(19) United States
(12) Patent Application Publication
(10) Pub. No.: US 2016/0061410 A1
(43) Pub. Date: Mar. 3, 2016

(54) OPTICAL DEVICE

(71) Applicant: SAMSUNG ELECTRONICS CO., LTD., Suwon-si (KR)

(72) Inventors: Seung Gyun JUNG, Suwon-si (KR); Tetsuo ARIYOSHI, Suwon-si (KR); Won Soo JI, Hwaseong-si (KR)

(21) Appl. No.: 14/693,516

(22) Filed: Apr. 22, 2015

(30) Foreign Application Priority Data
Aug. 28, 2014 (KR) 10-2014-0112988

(51) Int. Cl. F21V 5/04

(52) U.S. Cl. CPC F21V 5/048; F21V 5/045; F21Y 2101/00

(57) ABSTRACT

An optical device includes a first surface facing alight source, and including a recess portion formed in a central portion of the first surface through which an optical axis of light passes and a concave-convex pattern disposed around the recess portion, and a second surface which is disposed to oppose the first surface and at which the light incident through the recess portion is refracted and emitted externally. The recess portion may be recessed in a direction in which the light is emitted. The concave-convex pattern includes a plurality of convex portions and a plurality of concave portions alternatively and repetitively arranged in a direction outwardly from the recess portion toward an edge at which the first surface is connected to the second surface.

### CROSS-REFERENCE TO RELATED APPLICATION

This application claims priority to Korean Patent Application No. 10-2014-0112988, filed on Aug. 28, 2014, with the Korean Intellectual Property Office, the disclosure of which is incorporated herein by reference.

### BACKGROUND

The present disclosure relates to an optical device.

Among lenses used in light emitting device packages, wide beam angle lenses are used to allow light to be widely diffused from a central portion thereof using the principle of refraction. However, in a case in which a portion of light incident on a lens is reflected inside the lens to then move along a random optical path, a phenomenon in which light discharged outwardly from the lens is not uniformly distributed and partial increases in light amounts in certain light distribution regions may occur.

As such, optical non-uniformity defects such as mura may occur due to a non-uniform distribution of diffused light in lighting devices or display devices.

### SUMMARY

Some embodiments in the present disclosure may provide a scheme in which the occurrence of mura may be prevented and light may be uniformly distributed.

According to an aspect of the present disclosure, an optical device may include: a first surface facing a light source, and including a recess portion formed in a central portion of the first surface through which an optical axis of light passes and a concave-convex pattern disposed around the recess portion; and a second surface which is disposed to oppose the first surface and at which the light incident through the recess portion is refracted and emitted externally. The recess portion may be recessed in a direction in which light is emitted. The concave-convex pattern may include a plurality of convex portions and a plurality of concave portions alternatively and repetitively arranged in a direction outwardly from the recess portion toward an edge at which the first surface is connected to the second surface.

The concave-convex pattern may further include a plurality of protrusions arranged on surfaces of the plurality of convex portions.

The plurality of protrusions may be extendedly arranged from a respective convex portion to a respective concave portion.

The plurality of respective convex portions may have step structures.

The concave-convex pattern may have a form in which at least a portion of peaks of protrusions of the plurality of convex portions may be disposed on the same plane as the first surface.

The concave-convex pattern may have a form in which at least a portion of vertices of recessed portions of the plurality of concave portions are disposed on the same plane as the first surface.

The plurality of concave portions and the plurality of convex portions may be arranged to form concentric circles, based on the optical axis, respectively.

The plurality of concave portions and the plurality of convex portions may be disposed to have a spirally arranged form, based on the optical axis.

The second surface may include a first curved surface recessed along the optical axis toward the recess portion to have a concave curved surface, and a second curved surface having a convex curved surface continuously extended from an edge of the first curved surface to an edge of the second curved surface connected to the first surface.

The recess portion may be disposed above the light source to oppose the light source.

A transverse cross-sectional area of the recess portion exposed to the first surface may be larger than that of the light source.

The optical device may further include a support portion provided on the first surface.

According to an aspect of the present disclosure, an optical device may include: a first surface facing a light source, and including a recess portion formed in a central portion of the first surface through which an optical axis of light passes and a concave-convex pattern disposed around the recess portion; and a second surface which is disposed to oppose the first surface and at which the light incident through the recess portion is refracted and emitted externally. The recess portion may be recessed in a direction in which light is emitted. The concave-convex pattern may include a plurality of convex portions protruded from the first surface, and the plurality of convex portions may include a plurality of protrusions arranged on surfaces of the plurality of convex portions.

The concave-convex pattern may be repeatedly arranged in a direction outwardly from the recess portion toward an edge at which the first surface is connected to the second surface.

The concave-convex pattern may have a structure in which the plurality of convex portions are arranged to form concentric circles, based on the optical axis, respectively.

According to another aspect of the present disclosure, an optical device may include: a ring-shaped flat surface; a recess portion recessed away from an inner portion of the ring-shaped flat surface; a plurality of convex portions and a plurality of concave portions alternatively arranged from an outer portion of the ring-shaped flat surface along a direction away from an axis which passes through a center of the recess portion and which is perpendicular to the ring-shaped flat surface; and a second surface opposed to recess portion, the ring-shaped flat surface, the plurality of convex portions, and the plurality of concave portions. A major body of the optical device may be encompassed by a surface of the recess portion, the ring-shaped flat surface, surfaces of the plurality of convex portions, surfaces of the plurality of concave portions, and the second surface.

Along the direction away from the axis, a level of the second surface may first increase and then decrease with reference to a level of the ring-shaped flat surface.

The plurality of convex portions may have a plurality of protrusions arranged on the surfaces thereof or have step structures formed on the surfaces thereof.

An optical device may further include a support portion protruding from the ring-shaped flat surface.

The plurality of concave portions and the plurality of convex portions may be arranged to form concentric circles, with reference to the axis, respectively, or have a spirally arranged form, with reference to the axis.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic perspective view of an optical device according to an exemplary embodiment of the present disclosure;

FIG. 2 is a cross-sectional view of FIG. 1;

FIG. 3 is a schematic bottom view illustrating a concave-convex pattern of the optical device of FIG. 1;

FIG. 4 is a schematic bottom view illustrating a modified example of the concave-convex pattern of FIG. 3;

FIGS. 5A to 5C are partially enlarged cross sectional views of the concave-convex pattern of FIG. 1;

FIGS. 6A and 6B are schematic cross-sectional views illustrating an optical path of an optical device according to a comparative example and an optical path of an optical device according to an exemplary embodiment of the present disclosure, respectively;

FIGS. 7A and 7B are light distribution diagrams and graphs illustrating illuminance distribution of respective optical devices according to a comparative example and according to an exemplary embodiment of the present disclosure, respectively;

FIG. 8 is a cross sectional view of an optical device according to another exemplary embodiment of the present disclosure;

FIG. 9 is a schematic cross-sectional view of an optical device according to another exemplary embodiment of the present disclosure;

FIG. 10 is a schematic cross-sectional view of an optical device according to another exemplary embodiment of the present disclosure;

FIG. 11 is a schematic cross-sectional view of a light source module according to an exemplary embodiment of the present disclosure;

FIGS. 12A and 12B are cross-sectional views illustrating various examples of light emitting devices that maybe employed in the light source module of FIG. 11;

FIG. 13 illustrates a CIE 1931 chromaticity coordinate system;

FIGS. 14 to 16 are cross-sectional views illustrating various examples of a light emitting diode chip that may be employed in a light emitting device according to an exemplary embodiment of the present disclosure;

FIG. 17 is a schematic exploded perspective view of a lighting device (a bulb-type lighting device) according to an exemplary embodiment of the present disclosure;

FIG. 18 is a schematic exploded perspective view of a lighting device (an L-type lamp) according to an exemplary embodiment of the present disclosure; and

FIG. 19 is a schematic exploded perspective view of a lighting device (a flat-type lamp) according to an exemplary embodiment of the present disclosure.

### DETAILED DESCRIPTION

Embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements maybe exaggerated for clarity, and the same reference numerals will be used throughout to designate the same or like elements.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art. Unless explicitly described otherwise, the terms ‘on’, ‘upper part’, ‘upper surface’, ‘lower part’, ‘lower surface’, ‘upward’, ‘downward’, ‘side surface’, and the like will be used, based on the drawings, and may be changed depending on a direction in which a device or a constituent element is actually disposed.

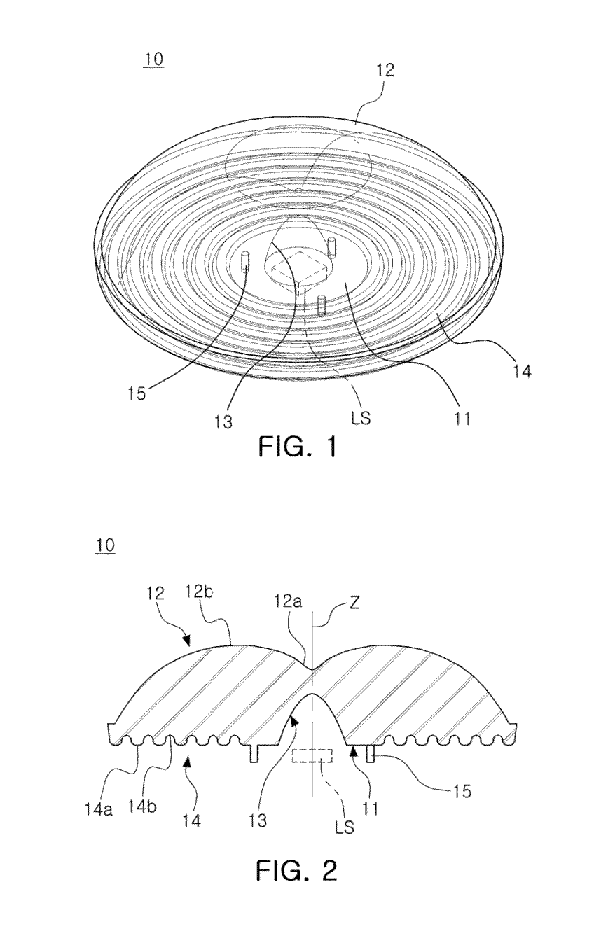

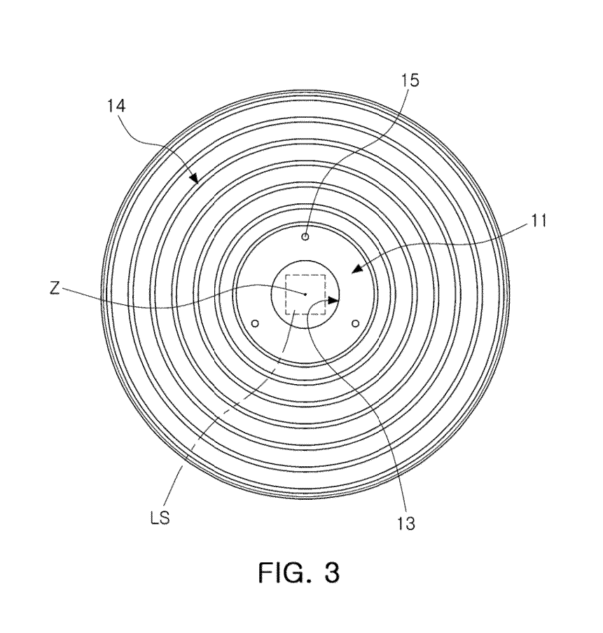

With reference to FIGS. 1 and 2, an optical device according to an exemplary embodiment of the present disclosure will be described. FIG. 1 is a schematic perspective view of an optical device according to an exemplary embodiment of the present disclosure, and FIG. 2 is a cross-sectional view of FIG. 1.

With reference to FIGS. 1 and 2, an optical device 10 according to an exemplary embodiment of the present disclosure may be disposed around a light source LS to adjust an angle in a spread of beams of light emitted from the light source LS. Here, the light source LS may include, for example, a light emitting device package. The optical device 10 may include a wide beam angle lens implementing a wide angle in a spread of light beams by allowing beams of light emitted by the device package to be spread.

As illustrated in FIGS. 1 and 2, the optical device 10 according to an exemplary embodiment of the present disclosure may include a first surface 11 disposed above the light source LS, and a second surface 12 opposing the first surface 11.

The first surface 11 may be disposed above the light source LS to be opposed thereto and may be provided as a bottom surface of the optical device 10. The first surface 11 may have a horizontal cross-sectional structure having an entirely flat circular shape.

The first surface 11 may have a recess portion 13 formed in a central portion thereof through which an optical axis Z of light from the light source LS passes. The recess portion 13 may be recessed in a direction in which light is emitted. The recess portion 13 may have a rotationally symmetrical structure with respect to the optical axis Z passing through a center of the optical device 10, and a surface of the recess portion 13 may be defined as a light incident surface on which light of the light source LS is incident. Thus, light generated by the light source LS may pass through the recess portion 13 to then move into the optical device 10. In other words, the recess portion 13 may be recessed away from an inner portion of a ring-shaped flat portion of the first surface 11.

The recess portion 13 may be open externally, through the first surface 11, and a transverse cross-sectional area of the recess portion 13 exposed to the first surface 11 may be larger than that of the light source LS. In addition, the recess portion 13 may be disposed to oppose the light source LS above the light source LS in a form in which it covers the light source LS. Thus, the light source LS may be disposed spaced-apart from the recess portion 13.

The first surface 11 may have a concave-convex pattern 14 disposed around the recess portion 13. The concave-convex pattern 14 may include a plurality of convex portions 14a and a plurality of concave portions 14b, and may have a structure in which the plurality of convex portions 14a and the plurality of concave portions 14b are alternately and repeatedly arranged, for example, a structure having a wave pattern shape, in a direction outwardly from the recess portion 13 toward an edge at which the first surface 11 is connected to the second surface 12. The concave-convex pattern 14 maybe extended from an outer portion of the ring-shaped flat portion of the first surface 11 along a direction away from the optical axis Z. A major body of the optical device 10 may be encompassed by a surface of the recess portion 13, the ring-shaped flat portion of the first surface 11, surfaces of the plurality of convex portions 14a, surfaces of the plurality of concave portions 14b, and the second surface 12.

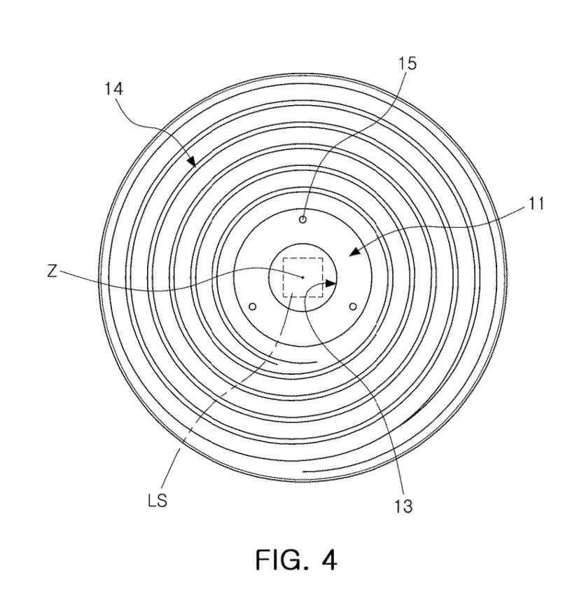

FIGS. 3 and 4 are plan views of the optical device, schematically illustrating the concave-convex pattern 14 viewed from a first surface 11 side of the optical device 10.

As illustrated in FIG. 3, the plurality of convex portions 14a and the plurality of concave portions 14b may respectively have ring shapes corresponding to a horizontal cross sectional shape of the optical device 10, and may form concentric circles, based on the optical axis Z. In addition, the plurality of convex portions 14a and the plurality of concave portions 14b maybe arranged in a radially distributed structure to form a periodic pattern such as a wave pattern.

In addition, as illustrated in FIG. 4, the plurality of convex portions 14a and the plurality of concave portions 14b may be formed to have a spirally arranged form continuously extended toward an edge of the optical device 10 from the recess portion 13, based on the optical axis Z.

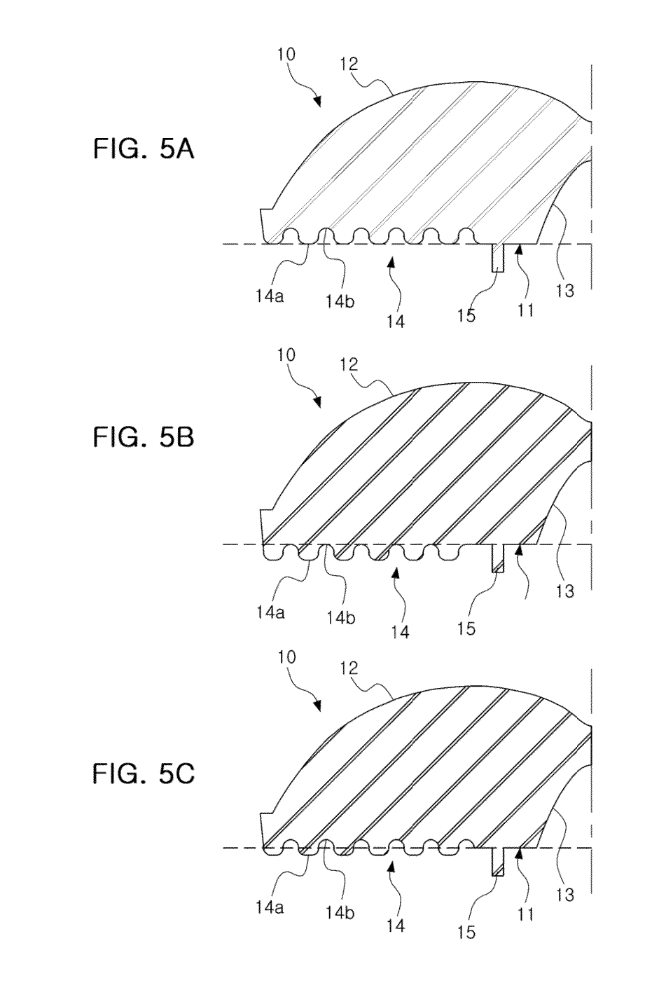

FIGS. 5A to 5C are partially enlarged cross sectional views of the concave-convex pattern 14 and schematically illustrate cross sections of the concave-convex pattern 14 of the optical device 10.

As illustrated in FIG. 5A, the concave-convex pattern 14 may have a form in which at least a portion of peaks of protrusions of the plurality of convex portions 14a are disposed on the same plane as the first surface 11. For example, the plurality of convex portions 14a and the plurality of concave portions 14b may be disposed on an inner side of the optical device 10, based on a level of the first surface 11.

In addition, as illustrated in FIG. 5B, the concave-convex pattern 14 may have a form in which at least a portion of vertices of recessed portions of the plurality of concave portions 14b are disposed on the same plane as the first surface 11. For example, the plurality of convex portions 14a and the plurality of concave portions 14b may be disposed on an outer side of the optical device 10, based on the level of the first surface 11.

In addition, as illustrated in FIG. 5C, the concave-convex pattern 14 may also have a structure in which the plurality of convex portions 14a are disposed on an outer side of the optical device 10 and the plurality of concave portions 14b are disposed on an inner side of the optical device 10, based on the level of the first surface 11.

A support portion 15 may protrude from the first surface 11. The support portion 15 may be integrally formed with the optical device 10 or attached to the first surface 11 using an adhesive or the like. The support portion 15 may be provided as a plurality of support portions 15.

For example, when the optical device 10 is mounted on a substrate, the support portion 15 may serve to fix and support the optical device 10 (see FIG. 11). The optical device 10 may be mounted on the substrate via the support portion 15. In addition, the first surface 11 may be disposed above the light source LS and the recess portion 13 may be disposed to oppose the light source LS.

The second surface 12 may be disposed to oppose the first surface 11 and may be provided as a light emission surface through which light incident through the recess portion 13 is refracted and emitted externally, and in detail, may be provided as an upper surface of the optical device 10. The second surface 12 may have a dorm shape having a convex upper portion in a form protruded in an upward direction from an edge thereof connected to the first surface 11, for example, in a direction in which light is emitted. In addition, the second surface 12 may have a structure in which a center thereof, through the optical axis Z passes, is recessed concavely toward the recess portion 13 so as to have an inflection point therein.

As illustrated in FIG. 2, the second surface 12 may have a first curved surface 12a recessed along the optical axis Z toward the recess portion 13 to have a concave curved surface, and a second curved surface 12b having a convex curved surface continuously extended from an edge of the first curved surface 12a to an edge of the second curved surface connected to the first surface 11. That is, along the direction away from the optical axis Z, a level of the second surface 12 may first increase and then decrease with reference to a level of the ring-shaped flat portion of the first surface 11.

The optical device 10 may be formed using a resin material having light transmissive properties, and for example, may contain polycarbonate (PC), polymethyl methacrylate (PMMA) acrylic, or the like. Further, the optical device 10 may be formed using a glass material, but a material of the optical device is not limited thereto.

The optical device 10 may contain a light dispersion material in a range of around 3% to 15%. As the light dispersion material, one or more selected from a group consisting of, for example, SiO₂, TiO₂ and Al₂O₃ may be used. In a case in which the light dispersion material is contained in a content of less than 3%, light may not be sufficiently distributed such that light dispersion effects may not be expected. In addition, in a case in which the light dispersion material is contained in a content of more than 15%, an amount of light emitted outwardly from the optical device 10 may be reduced, thus deteriorating light extraction efficiency.

The optical device 10 may be formed using a method of injecting a liquid solvent into a mold to be solidified. For example, an injection molding method, a transfer molding method, a compression molding method, or the like may be used.

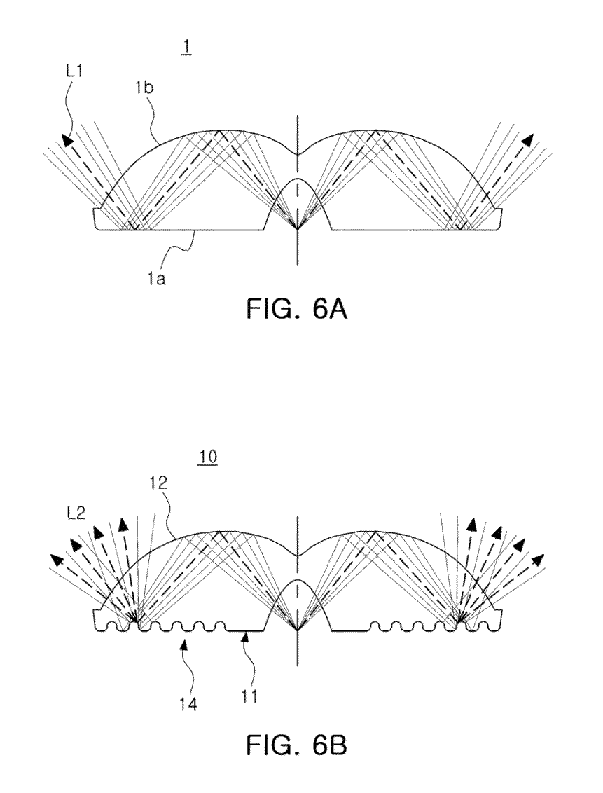

FIGS. 6A and 6B schematically illustrate an optical path of an optical device according to a comparative example and an optical path of an optical device according to an exemplary embodiment of the present disclosure.

An optical device such as a lens may facilitate uniformly diffusing of light from a central portion thereof using refraction, but in a case in which light deviates from refraction conditions, for example, in the case of Fresnel reflection or total reflection, light may not be uniformly distributed or light loss may occur. Such refraction conditions may be determined by an angle of light incident on a light emission surface of the optical device, a boundary surface at the time of the movement of light by air in the optical device, for example, determined by an angle of light incident on the second surface.

According to a design of the optical device, light may be reflected into the optical device from a portion of a region of the second surface by the total reflection or Fresnel reflection to then move to the first surface. Then, the light may be re-reflected from the first surface to the second surface.

As illustrated in FIG. 6A, in the case of an optical device 1 of the comparative example having a structure in which a bottom surface of the optical device is flat, when light L1 reflected from a first surface 1a to then move to a second surface 1b is discharged outwardly from the optical device 1 through the second surface 1b, light L1 from the optical device 1 tends to be distributed by being partially concentrated in a light distribution region in a lateral direction of the optical device 1.

On the other hand, as illustrated in FIG. 6B, in an optical device 10 according to an exemplary embodiment of the present disclosure, light L2 reflected from a second surface 12 to move a first surface 11 may be reflected in various directions by a concave-convex pattern 14 provided on the first surface 11, and thus, when the light L2 is emitted outwardly from the optical device 10 from the second surface 12, the light L2 tends to be scattered in various directions other than being concentrated on a portion of a region.

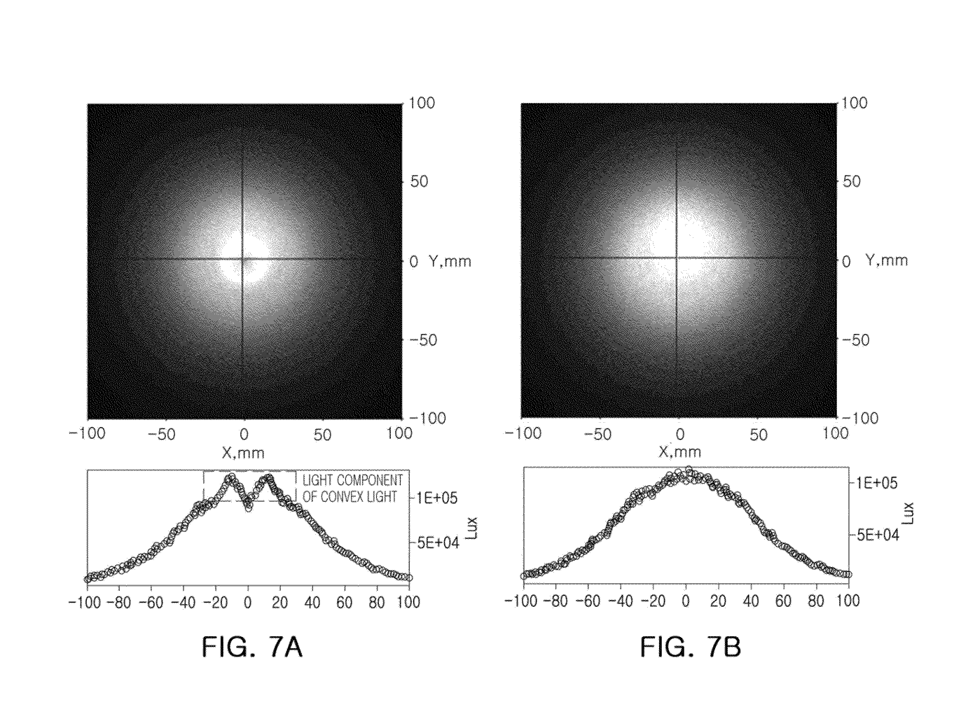

FIGS. 7A and 7B are light distribution diagrams and graphs illustrating illuminance distribution of respective optical devices.

As illustrated in FIG. 7A, in an optical device 1 according to a comparative example, it can be appreciated that light distribution is partially increased in a light distribution region adjacent to an optical axis, and thus, uniformity in terms of overall light distribution is deteriorated. Such a non-uniform light distribution may cause the occurrence of defects such as mura in a lighting device, a display device, or the like.

On the other hand, as illustrated in FIG. 7B, it can be appreciated that in the optical device 10 according to the exemplary embodiment of the present disclosure, light distribution is increased at the light axis, while the light distribution is reduced in inverse proximity to the optical axis while having symmetry therewith. Thus, unlike FIG. 7A, it can be confirmed from FIG. 7B that the uniformity of light distribution is significantly increased.

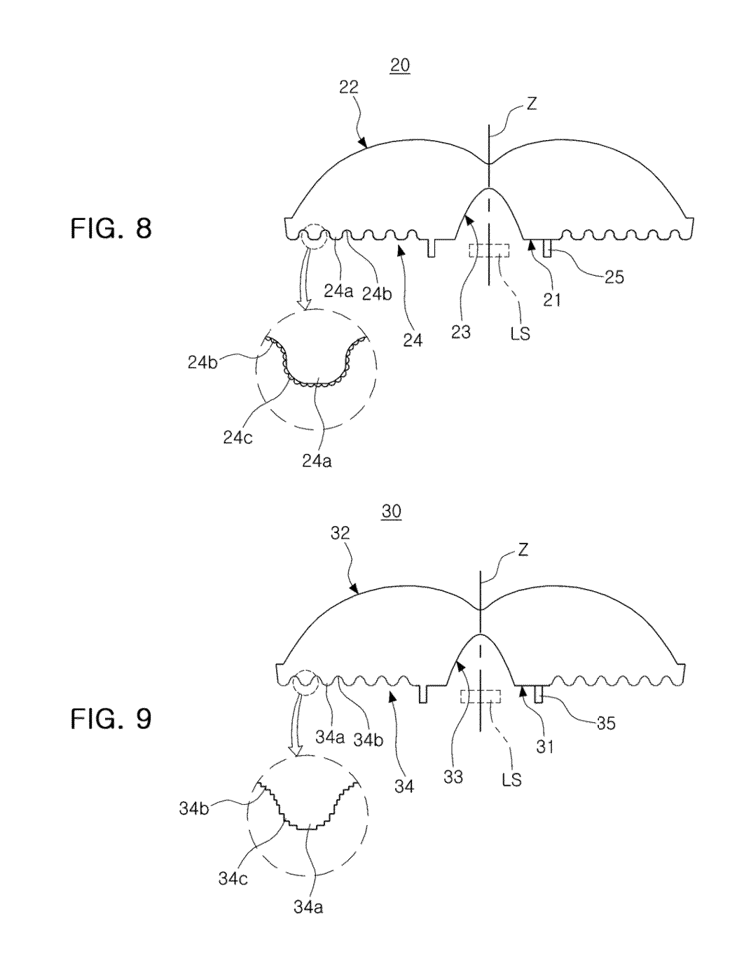

An optical device according to another exemplary embodiment of the present disclosure will be described with reference to FIG. 8. FIG. 8 is a cross sectional view of an optical device according to another exemplary embodiment of the present disclosure.

A structure configuring an optical device 20 according to the exemplary embodiment of the present disclosure, illustrated with reference to FIG. 8, is substantially the same as that of the exemplary embodiment of the present disclosure with reference to FIGS. 1 to 5 in terms of a basic structure. However, since a structure of a concave-convex pattern 24 is different from that of the exemplary embodiment of the present disclosure with reference to FIGS. 1 to 5, a description thereof overlapping the description of the exemplary embodiment of the present disclosure with reference to FIGS. 1 to 5 will be omitted below, and the structure of the concave-convex pattern 24 will mainly be described hereinafter.

With reference to FIG. 8, the optical device 20 according to the exemplary embodiment of the present disclosure may include a first surface 21 disposed above a light source LS, and a second surface 22 disposed to oppose the first surface 21.

The first surface 21 may have a recess portion 23 formed in a central portion thereof through which an optical axis Z of light from the light source LS passes. The recess portion 23 may be recessed in a direction in which light is emitted. The recess portion 23 may have a rotationally symmetrical structure with respect to the optical axis Z passing through a center of the optical device 20, and a surface of the recess portion 23 may be defined as a light incident surface on which light of the light source LS is incident. The recess portion 23 may be open externally, through the first surface 21, and an area of a transverse cross section thereof exposed to the first surface 21 may be larger than that of the light source LS.

The first surface 21 may have a concave-convex pattern 24 disposed around the recess portion 23. The concave-convex pattern 24 may include a plurality of convex portions 24a and a plurality of concave portions 24b, and may have a structure in which the plurality of convex portions 24a and the plurality of concave portions 24b are alternately and repeatedly arranged, for example, a structure having a wave pattern shape, formed in a direction outwardly from the recess portion 23 toward an edge at which the first surface 21 is connected to the second surface 22.

In addition, the first surface 21 may include a plurality of support portions 25.

In a manner similar to that of the concave-convex pattern 14 illustrated in FIG. 3, in the case of the concave-convex pattern 24 according to the exemplary embodiment of the present disclosure, the plurality of convex portions 24a and the plurality of concave portions 24b may also respectively have ring shapes, corresponding to a horizontal cross sectional shape of the optical device 20, and may form concentric circles, based on the optical axis Z. In addition, the plurality of convex portions 24a and the plurality of concave portions 24b may be arranged in a radially distributed structure while forming a periodic pattern such as a wave pattern.

In addition, in a manner similar to the case of FIG. 4, the plurality of convex portions 24a and the plurality of concave portions 24b may be formed to have a spirally arranged form continuously extended toward an edge of the optical device 20 from the recess portion 23, based on the optical axis Z.

On the other hand, the concave-convex pattern 24 may further include a plurality of protrusions 24c arranged on surfaces of the plurality of convex portions 24a. The plurality of protrusions 24c may be extendedly arranged from the convex portion 24a to the concave portion 24b on surfaces thereof.

The plurality of protrusions 24c maybe protruded from surfaces of the plurality of convex portions 24a, or from surfaces of the plurality of convex portions 24a and the plurality of concave portions 24b so as to have a form covering the surfaces of the convex portions 24a and the concave portions 24b. In addition, the plurality of protrusions 24c may be arranged in a symmetrical or asymmetrical structure, based on peaks of protrusions of the respective convex portions 24a.

The plurality of protrusions 24c may have a hemispherical curved surface, but are not limited thereto. For example, the plurality of protrusions 24c may have various shapes such as a triangular shape, a quadrangular shape, or the like.

In addition, besides the structure in which as in the exemplary embodiment of the present disclosure, the surfaces of the convex portions 24a and the concave portions 24b are overall covered with the protrusions, a structure in which the plurality of protrusions are spaced apart from each other and arranged to have an interval therebetween so as to partially cover the surfaces of the convex portions 24a and the concave portions 24b may also be applied.

As such, the concave-convex pattern 24 according to the exemplary embodiment of the present disclosure may have a concave-convex structure having a double protrusion form in which the plurality of convex portions 24a and the plurality of concave portions 24b arranged on the first surface 21 are included, and further, the plurality of protrusions 24c arranged on the surfaces of the plurality of convex portions 24a and the plurality of concave portions 24b are included.

By using a structure of such a concave-convex pattern 24, light maybe scattered and diffused over a relatively wide region. Thus, overall light uniformity may be improved.

An optical device according to another exemplary embodiment of the present disclosure will be described with reference to FIG. 9. FIG. 9 is a schematic cross-sectional view of an optical device according to another exemplary embodiment of the present disclosure.

A structure configuring an optical device 30 according to the exemplary embodiment of the present disclosure, illustrated with reference to FIG. 9, is substantially the same as that of the exemplary embodiment of the present disclosure with reference to FIGS. 1 to 5 in terms of a basic structure thereof. However, since a structure of a concave-convex pattern 34 is different from that of the exemplary embodiment of the present disclosure with reference to FIGS. 1 to 5, a description thereof overlapping the description of the exemplary embodiment of the present disclosure with reference to FIGS. 1 to 5 will be omitted below, and the structure of the concave-convex pattern 34 will mainly be described.

With reference to FIG. 9, the optical device 30 according to the exemplary embodiment of the present disclosure may include a first surface 31 disposed above a light source LS, and a second surface 32 disposed to oppose the first surface 31.

The first surface 31 may have a recess portion 33 formed in a central portion thereof through which an optical axis Z of light from the light source LS passes. The recess portion 33 may be recessed in a direction in which light is emitted. The recess portion 33 may have a rotationally symmetrical structure with respect to the optical axis Z passing through a center of the optical device 30, and a surface of the recess portion 33 may be defined as a light incident surface on which light of the light source LS is incident. The recess portion 33 may be open externally, through the first surface 31, and an area of a transverse cross section thereof exposed to the first surface 31 may be larger than that of the light source LS.

In addition, the first surface 31 may include a plurality of support portions 35.

The first surface 31 may have a concave-convex pattern 34 disposed around the recess portion 33. The concave-convex pattern 34 may include a plurality of convex portions 34a and a plurality of concave portions 34b, and may have a structure in which the plurality of convex portions 34a and the plurality of concave portions 34b are alternately and repeatedly arranged, for example, a structure having a wave pattern shape, formed in a direction outwardly from the recess portion 33 toward an edge at which the first surface 31 is connected to the second surface 32.

In a manner similar to the concave-convex pattern 14 illustrated in FIG. 3, in the case of the concave-convex pattern 34 according to the exemplary embodiment of the present disclosure, the plurality of convex portions 34a and the plurality of concave portions 34b may also respectively have ring shapes corresponding to a horizontal cross-sectional shape of the optical device 30, and may form concentric circles, based on the optical axis Z. In addition, the plurality of convex portions 34a and the plurality of concave portions 34b may be arranged in a radially distributed structure while forming a periodic pattern such as a wave pattern.

In addition, in a manner similar to the case of FIG. 4, the plurality of convex portions 34a and the plurality of concave portions 34b may be formed to have a spirally arranged form continuously extended toward an edge of the optical device 30 from the recess portion 33, based on the optical axis Z.

On the other hand, the plurality of convex portions 34a may have a structure in which a plurality of step structures 34c are formed in a surface thereof. Further, the plurality of concave portions 34b may also have step structures formed in surfaces thereof to correspond to the structure of the convex portions 34a.

The plurality of step structures 34c may have various sizes in a vertical direction along the optical axis Z, for example, a structure in which the sizes of the step structures in a downward direction thereof are reduced in a direction toward the light source.

As such, the concave-convex pattern 34 according to the exemplary embodiment of the present disclosure may include the plurality of convex portions 34a and the plurality of concave portions 34b arranged on the first surface 31, and may have a structure in which the plurality of convex portions 34a and the plurality of concave portions 34b have the step structures 34c in surfaces thereof.

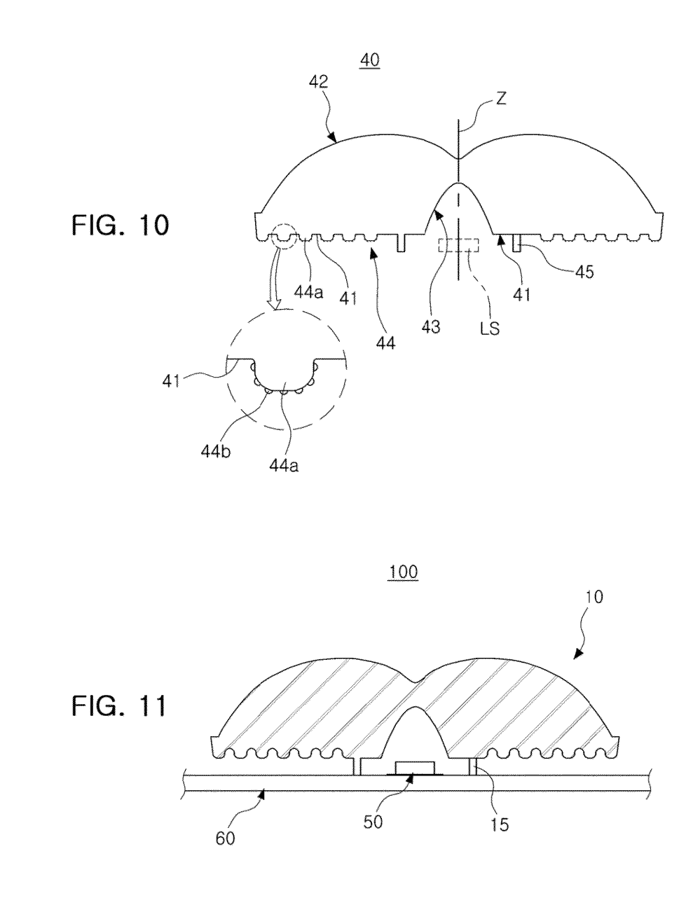

An optical device according to another exemplary embodiment of the present disclosure will be described with reference to FIG. 10. FIG. 10 is a schematic cross-sectional view of an optical device according to another exemplary embodiment of the present disclosure.

A structure configuring an optical device 40 according to the exemplary embodiment of the present disclosure, illustrated with reference to FIG. 10, is substantially the same as that of the exemplary embodiment of the present disclosure with reference to FIGS. 1 to 5 in terms of a basic structure. However, since a structure of a concave-convex pattern 44 is different from that of the exemplary embodiment of the present disclosure with reference to FIGS. 1 to 5, a description thereof overlapping the description of the exemplary embodiment of the present disclosure with reference to FIGS. 1 to 5 will be omitted below, and the structure of the concave-convex pattern 44 will mainly be described.

With reference to FIG. 10, the optical device 40 according to the exemplary embodiment of the present disclosure may include a first surface 41 disposed above a light source LS, and a second surface 42 disposed to oppose the first surface 41.

The first surface 41 may have a recess portion 43 formed in a central portion thereof through which an optical axis Z of light from the light source LS passes. The recess portion 43 may be recessed in a direction in which light is emitted. The recess portion 43 may have a rotationally symmetrical structure with respect to the optical axis Z passing through a center of the optical device 40, and a surface of the recess portion 43 may be defined as a light incident surface on which light of the light source LS is incident. The recess portion 43 may be open externally, through the first surface 41, and an area of a transverse cross section thereof exposed to the first surface 41 may be larger than that of the light source LS.

In addition, the first surface 41 may include a plurality of support portions 45.

The first surface 41 may have a concave-convex pattern 44 disposed around the recess portion 43. The concave-convex pattern 44 may include a plurality of convex portions 44a protruding from the first surface 41 and may have a structure in which the plurality of convex portions 44a are repeatedly arranged in a direction outwardly from the recess portion 43 toward an edge at which the first surface 41 is connected to the second surface 42.

In a manner similar to the concave-convex pattern 14 illustrated in FIG. 3, in the case of the concave-convex pattern 44 according to the exemplary embodiment of the present disclosure, the plurality of convex portions 44a may also respectively have ring shapes corresponding to a horizontal cross-sectional shape of the optical device 40, and may form concentric circles, based on the optical axis Z. In addition, the plurality of convex portions 44a may be arranged in a radially distributed structure while forming a periodic pattern.

In addition, in a manner similar to the case of FIG. 4, the plurality of convex portions 44a may be formed to have a spirally arranged form continuously extended toward an edge of the optical device 40 from the recess portion 43, based on the optical axis Z.

On the other hand, the plurality of convex portions 44a may have a plurality of protrusions 44b arranged on a respective surface thereof.

The plurality of protrusions 44b maybe protruded from surfaces of the plurality of convex portions 44a in a form covering the surface of a corresponding convex portion 44a. In addition, the plurality of protrusions 44b may be arranged in a symmetrical or asymmetrical structure, based on a peak of a respective convex portion 44a.

The plurality of protrusions 44b may have a hemispherical curved surface, but are not limited thereto. For example, the plurality of protrusions 24c may have various shapes such as a triangular shape, a quadrangular shape, or the like.

A light source module 100 according to an exemplary embodiment of the present disclosure will be described with reference to FIG. 11. FIG. 11 is a schematic cross-sectional view of a light source module according to an exemplary embodiment of the present disclosure.

With reference to FIG. 11, the light source module 100 according to an exemplary embodiment of the present disclosure may include alight emitting device 50, a substrate 60 on which the light emitting device 50 is mounted, and an optical device 10 disposed above the light emitting device 50.

The light emitting device 50 may be provided as a photoelectric device generating light of a predetermined wavelength through externally-supplied driving power. For example, the light emitting device 50 may include a semiconductor light emitting diode (LED) chip having, for example, an n-type semiconductor layer, a p-type semiconductor layer, and an active layer disposed therebetween, or a package including such a semiconductor light emitting diode chip.

The light emitting device 50 may emit blue light, green light or red light according to a material contained therein or according to a combination thereof with a phosphor, and may also emit white light, ultraviolet light, or the like.

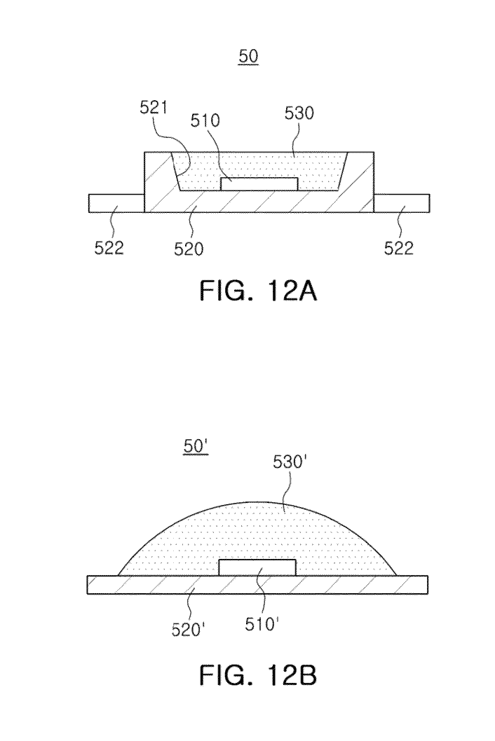

As illustrated in FIG. 12A, the light emitting device 50 may have a package structure in which an LED chip 510 is mounted within a body 520 having a reflective cup 521 therein.

The body 520 may be provided as a base member in which the LED chip 510 is mounted to be supported thereby, and maybe formed using a white molding compound having relatively high light reflectivity, by which an effect of increasing an amount of light emitted externally by allowing light emitted from the LED chip 510 to be reflected may be obtained. Such a white molding compound may contain a thermosetting resin-based material having high heat resistance or a silicon resin-based material. In addition, a white pigment and a filling material, a hardener, a mold release agent, an antioxidant, an adhesion improver, or the like, may be added to the thermosetting resin-based material. In addition, the body 520 may also be formed using FR-4, CEM-3, an epoxy material, a ceramic material, or the like. In addition, the body 520 may also be formed using a metal such as aluminum (Al).

The body 520 may include a lead frame 522 for an electrical connection to an external power source. The lead frame 522 may be formed using a material having excellent electrical conductivity, for example, a metal such as aluminum, copper, or the like. For example, when the body 520 is formed using a metal, an insulation material may be interposed between the body 520 and the lead frame 522.

In the case of the reflective cup 521 provided in the body 520, the lead frame 522 may be exposed to a bottom surface on which the LED chip 510 is mounted. The LED chip 510 may be electrically connected to the exposed lead frame 522.

The reflective cup 521 may have a structure in which an area of a transverse cross section of a surface thereof exposed to an upper part of the body 520 is greater than that of a bottom surface of the reflective cup 521. Here, the surface of the reflective cup 521 exposed to the upper part of the body 520 may be defined as a light emission surface of the light emitting device 50.

On the other hand, the LED chip 510 may be sealed by an encapsulation portion 530 formed in the reflective cup 521 of the body 520. The encapsulation portion 530 may contain a wavelength conversion material.

As the wavelength conversion material, for example, at least one or more phosphors excited by light generated in the LED chip 510 to thus emit light having a different wavelength may be used and contained in the encapsulation portion, so that light having various colors as well as white light may be emitted through control thereof.

For example, when the LED chip 510 emits blue light, white light may be emitted through a combination of yellow, green, red or orange phosphors therewith. In addition, the light source module may also be configured to include at least one light emitting device emitting violet, blue, green, red or infrared light. In this case, the LED chip 510 may perform controlling so that a color rendering index (CRI) thereof may be controlled from sodium (Na) light, having a CRI of 40, to a solar level having a CRI of 100, and further, may emit various types of white light having a color temperature of around 2000K to around 20000K. In addition, color may be adjusted to be appropriate for an ambient atmosphere or for people's moods by generating visible violet, blue, green, red or orange light as well as infrared light as needed. Further, light within a special wavelength band, capable of promoting growth of plant, may also be generated.

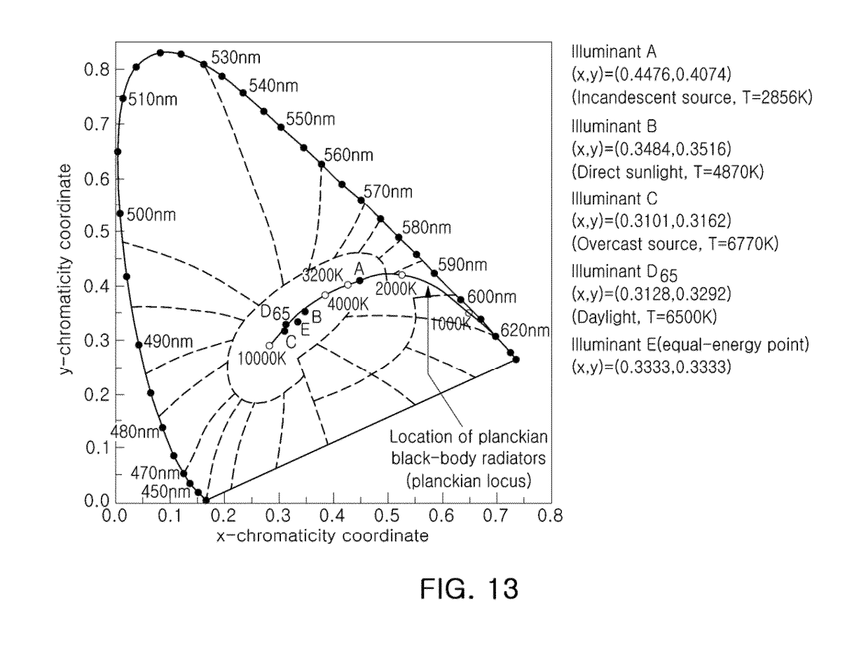

White light obtained by combining yellow, green, red phosphors and/or green, red LEDs with the blue LED may have two or more peak wavelengths, and coordinates (x, y) of the CIE 1931 chromaticity coordinate system illustrated in FIG. 13 may be located on line segments (0.4476, 0.4074), (0.3484, 0.3516), (0.3101, 0.3162), (0.3128, 0.3292), and (0.3333, 0.3333) connected to one another. Alternatively, the coordinates (x, y) may be located in a region surrounded by the line segments and black body radiation spectrum. A color temperature of the white light may be in a range of 2000K to 20000K.

Phosphors may be represented by the following empirical formulae and have a color as below.

Oxide-based Phosphors: Yellow and green Y₃Al₅O₁₂:Ce, Tb₃Al₅O₁₂:Ce, Lu₃Al₅O₁₂:Ce

Silicate-based Phosphor: Yellow and green (Ba, Sr)₂SiO₄:Eu, Yellow and yellowish-orange (Ba, Sr)₃SiO₅:Ce

Nitride-based Phosphors: Green β-SiAlON:Eu, Yellow La₃Si₆N₁₁:Ce, Yellowish-orange α-SiAlON:Eu, Red CaAlSiN³:Eu, Sr₂Si₅N₈:Eu, SrSiAl₄N₇:Eu

Fluoride-based Phosphors: KSF-based red K₂SiF₆:Mn4+

A composition of phosphors should basically coincide with stoichiometry, and respective elements may be substituted with other elements in respective groups of the periodic table of elements. For example, Sr may be substituted with Ba, Ca, Mg, or the like, of an alkaline earth group II, and Y may be substituted with lanthanum-based Tb, Lu, Sc, Gd, or the like. In addition, Eu or the like, an activator, may be substituted with Ce, Tb, Pr, Er, Yb, or the like, according to a required level of energy, and an activator alone or a sub-activator or the like, for modification of characteristics thereof, may additionally be used.

In addition, as a phosphor substitute, materials such as a quantum dot (QD) or the like maybe used, and a phosphor and a quantum dot alone, or a mixture thereof, may be used.

The quantum dot (QD) maybe configured in a structure including a core (3 to 10 nm) formed using CdSe, InP, or the like, a shell (0.5 to 2 nm) formed using ZnS, ZnSe, or the like, and a ligand for stabilization of the core and the shell, and may implement various colors depending on the size thereof.

Although the exemplary embodiment of the present disclosure illustrates the case in which the light emitting device 50 has a package structure in which the LED chip 510 is provided within the body 520 having the reflective cup 421, exemplary embodiments of the present disclosure are not limited thereto. For example, as illustrated in FIG. 12B, a light emitting device 50′ may have a chip-on-board (COB) structure in which an LED chip 510′ is mounted on an upper surface of a body 520′. In this case, the body 520′ may be a circuit board in which a circuit wiring is formed, and an encapsulation portion 530′ may have a lens structure protruding from an upper surface of the body 520′ to cover the LED chip 510′.

In addition, the exemplary embodiment of the present disclosure illustrates the case in which the light emitting device 50 is a single package product, but is not limited thereto. For example, the light emitting device 50 may be the LED chip 510 itself.

With reference to FIG. 11, the substrate 60 may be provided as an FR4-type printed circuit board (PCB) or a flexible printed circuit board liable to be flexed, and may be formed using an organic resin material containing epoxy, triagine, silicon rubber, polyamide, or the like, and a further organic resin material. The substrate 60 may also be formed using a ceramic material such as AlN, Al₂O₃ or the like, or formed using a metal or a metal compound as in a metal core printed circuit board (MCPCB), a metal copper clad laminate (MCCL), or the like.

The substrate 60 may include a circuit wiring electrically connected to the light emitting device 50.

The optical device 10 may be substantially the same as the optical device illustrated in FIGS. 1 to 10, and a description thereof will thus be omitted.

The exemplary embodiment of the present disclosure illustrates the case in which the light source module 100 are configured of a single light emitting device 50 mounted on the substrate 60 and a single optical device 10, but is not limited thereto. For example, the light emitting device 50 may be provided as a plurality of light emitting devices to be arranged on the substrate 60, and the optical device 10 may be provided in plural to correspond to the plurality of light emitting devices 50 and may be disposed above the respective light emitting device 50.

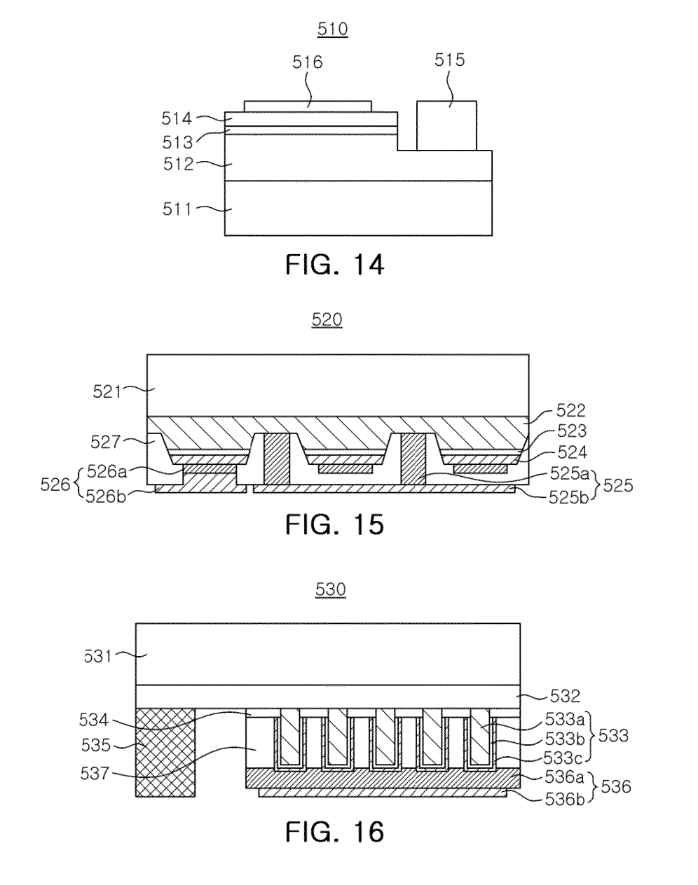

Various examples of an LED chip that maybe employed in a light emitting device will be described with reference to FIGS. 14 to 16. FIGS. 14 to 16 are cross-sectional views illustrating various examples of a light emitting diode chip that may be employed in a light emitting device according to an exemplary embodiment of the present disclosure.

With reference to FIG. 14, an LED chip 510 may include a first conductivity-type semiconductor layer 512, an active layer 513, and a second conductivity-type semiconductor layer 514, sequentially stacked on a growth substrate 511.

The first conductivity-type semiconductor layer 512 stacked on the growth substrate 511 maybe an n-type nitride semiconductor layer doped with an n-type impurity. The second conductivity-type semiconductor layer 514 may be a p-type nitride semiconductor layer doped with a p-type impurity. However, according to an exemplary embodiment of the present disclosure, locations of the first and second conductivity-type semiconductor layers 512 and 514 in a scheme in which they are stacked on each other may also be reversed. The first and second conductivity-type semiconductor layers 512 and 514 may be formed using a material represented by an empirical formula AlₓIn_{y}Ga(_{1-x-y})N (here, 0≦x<1, 0≦y<1, 0≦x+y<1), such as GaN, AlGaN, InGaN, AlInGaN, or the like.

The active layer 513 disposed between the first and second conductivity-type semiconductor layers 512 and 514 may emit light having a predetermined level of energy through the recombination of electrons and holes. The active layer 513 may contain a material having an energy band gap smaller than those of the first and second conductivity-type semiconductor layers 512 and 514. For example, when the first and second conductivity-type semiconductor layers 512 and 514 are configured of a GaN-based compound semiconductor, the active layer 513 may include an InGaN-based compound semiconductor having an energy band gap smaller than that of GaN. In addition, the active layer 513 may have a multiple quantum well structure in which a quantum well layer and a quantum barrier layer are alternately stacked, for example, a InGaN/GaN structure, but is not limited thereto. Thus, the active layer 513 may have a single quantum well structure (SQW).

The LED chip 510 may include first and second electrode pads 515 and 516 respectively and electrically connected to the first and second conductivity-type semiconductor layers 512 and 514. The first and second electrode pads 515 and 516 may be exposed and disposed so as to be located in a single direction, and further, may be electrically connected to a substrate in a wire bonding scheme or a flip-chip bonding scheme.

An LED chip 520 illustrated in FIG. 15 may include a semiconductor laminate formed on a growth substrate 521. The semiconductor laminate may include a first conductivity-type semiconductor layer 522, an active layer 523, and a second conductivity-type semiconductor layer 524.

The LED chip 520 may include first and second electrode pads 525 and 526 respectively connected to the first and second conductivity-type semiconductor layers 522 and 524. The first electrode pad 525 may include a conductive via 525a penetrating the second conductivity-type semiconductor layer 524 and the active layer 523 to be connected to the first conductivity-type semiconductor layer 522, and an electrode extension portion 525b connected to the conductive via 525a. The conductive via 525a may be surrounded by an insulating layer 527 to be electrically isolated from the active layer 523 and the second conductivity-type semiconductor layer 524. In the LED chip 520, the conductive via 525a maybe formed in a region thereof in which the semiconductor laminate has been etched. The number, a shape, or a pitch of the conductive vias 525a, or a contact area thereof with the first conductivity-type semiconductor layer 522, and the like, may be appropriately designed, such that contact resistance is reduced. In addition, the conductive vias 525a may be arranged so that rows and columns thereof may be formed on the semiconductor laminate, thereby improving current flow. The second electrode pad 526 may include an ohmic contact layer 526a formed on the second conductivity-type semiconductor layer 524, and an electrode extension portion 526b.

An LED chip 530 illustrated in FIG. 16 may include a growth substrate 531, a first conductivity-type semiconductor base layer 532 formed on the growth substrate 531, and a plurality of nano-light emitting structures 533 formed on the first conductivity-type semiconductor base layer 532. The LED chip 530 may further include an insulating layer 534 and a filling portion 537.

The nano light emitting structure 533 may include a first conductivity-type semiconductor core 533a, and an active layer 533b and a second conductivity-type semiconductor layer 533c which are formed as cell layers on a surface of the first conductivity-type semiconductor core 533a and sequentially formed thereon.

The exemplary embodiment of the present disclosure illustrates the case in which the nano light emitting structure 533 has a core-shell structure, but is not limited thereto, and may have various structures such as a pyramid structure. The first conductivity-type semiconductor base layer 532 may serve as a layer providing a growth surface of the nano light emitting structure 533. The insulating layer 534 may provide an open region for the growth of the nano light emitting structure 533, and may be formed using a dielectric material such as SiO₂ or SiNₓ. The filling portion 537 may serve to structurally stabilize the nano light emitting structures 533 and may serve to allow light to penetrate therethrough or be reflected therefrom. In a manner different therefrom, in a case in which the filling portion 537 contains a light transmitting material, the filling portion 537 may be formed using a transparent material such as SiO₂, SiNx, an elastic resin, silicone, an epoxy resin, a polymer or a plastic material. As necessary, in a case in which the filling portion 537 contains a reflective material, a ceramic powder or a metal powder having a high degree of reflectivity may be used in a polymer material such as polypthalamide (PPA) or the like, in the filling portion 537. As the high reflectivity ceramic material, at least one selected from a group consisting of TiO₂, Al₂O₃, Nb₂O₅, Al₂O₃ and ZnO may be used. In a manner different therefrom, high reflectivity metal may also be used, and a metal such as Al or Ag may be used.

The first and second electrode pads 535 and 536 may be disposed on lower surfaces of the nano light emitting structures 533. The first electrode pad 535 may be disposed on an exposed upper surface of the first conductivity-type semiconductor base layer 532, and the second electrode pad 536 may include an ohmic contact layer 536a formed on lower portions of the nano light emitting structures 533 and the filling portion 537, and an electrode extension portion 536b. In a manner different therefrom, the ohmic contact layer 536a and the electrode extension portion 536b may be integrally formed.

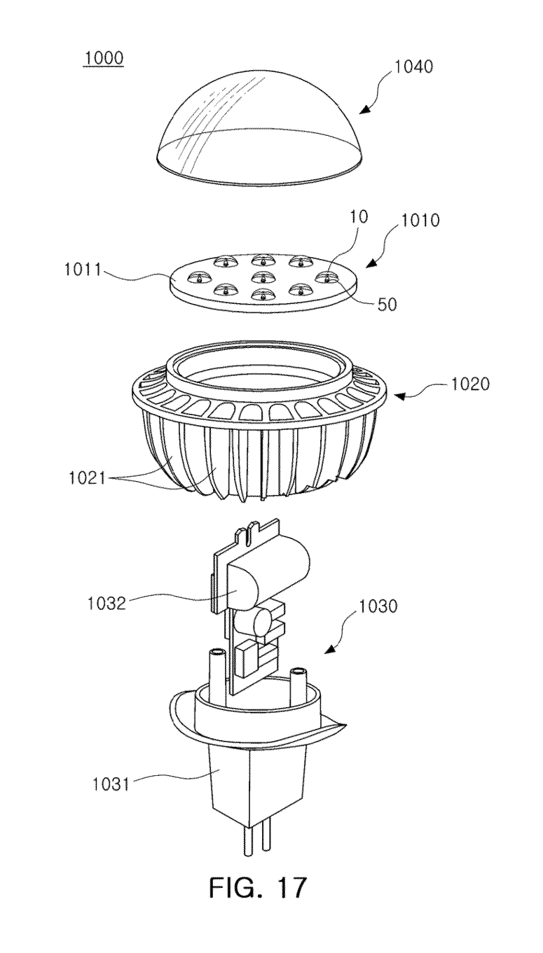

Lighting devices according to various exemplary embodiments of the present disclosure, employing a light source module of the present disclosure, will be described with reference to FIGS. 17 to 19.

FIG. 17 schematically illustrates a lighting device according to an exemplary embodiment of the present disclosure.

With reference to FIG. 17, a lighting device 1000 according to an exemplary embodiment of the present disclosure may be a bulb-type lamp and may be used as an apparatus for indoor lighting, for example, a downlight. The lighting device 1000 may include a housing 1020 having an electrical connection structure 1030, and at least one light source module 1010 installed on the housing 1020. The lighting device 1000 may further include a cover 1040 mounted on the housing 1020 to cover the at least one light source module 1010.

The light source module 1010 may be substantially the same as the light source module 100 of FIG. 11, and thus, a detailed description thereof will be omitted. The light source module 1010 may be configured to include a plurality of light emitting devices 50 and a plurality of optical devices 10 mounted on a substrate 1011 (see FIG. 11)

The housing 1020 may serve as a frame supporting the light source module 1010 and a heat sink discharging heat generated in the light source module 1010 to the outside. To this end, the housing 1020 may be formed using a solid material having relatively high heat conductivity, for example, a metal such as aluminum (Al), a radiation resin, or the like.

The housing 1020 may include a plurality of radiation fins 1021 provided on an outer circumferential surface thereof, to allow for an increase in a contact area with surrounding air so as to improve heat radiation efficiency.

The housing 1020 may include the electrical connection structure 1030 electrically connected to the light source module 1010. The electrical connection structure 1030 may include a terminal portion 1031, and a driving portion 1032 supplying driving power to the light source module 1010 through the terminal portion 1031.

The terminal portion 1031 may allow the lighting device 1000 to be installed on, for example, a socket or the like, so as to be fixed and electrically connected thereto. The exemplary embodiment of the present disclosure illustrates the case in which the terminal portion 1031 has a pin-type structure so as to be slidably inserted, but is not limited thereto. The terminal portion 1031 may have an Edison type structure having a screw thread so that it may be rotatably inserted, as needed.

The driving portion 1032 may serve to convert external driving power into an appropriate current source capable of driving the light source module. The driving portion 1032 may be configured of, for example, an AC to DC converter, a rectifying circuit component, a fuse, and the like. In addition, in some cases, the driving portion 1032 may further include a communications module capable of implementing a remote control function.

The cover 1040 may be installed on the housing 1020 to cover the at least one light source module 1010 and may have a convex lens shape or a bulb shape. The cover 1040 may be formed using a light transmitting material and may contain a light dispersion material.

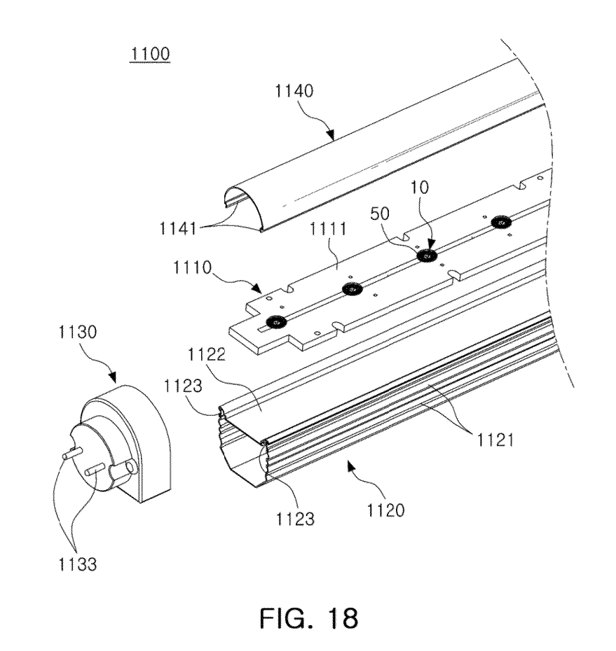

FIG. 18 is a schematic exploded perspective view of a lighting device according to another exemplary embodiment of the present disclosure. With reference to FIG. 18, a lighting device 1100 may be a bar type lamp by way of example, and may include a light source module 1110, a housing 1120, a terminal portion 1130, and a cover 1140.

As the light source module 1110, the light source module of FIG. 11 may be employed. Thus, a detailed description thereof will be omitted. The light source module 1110 may be configured to include a plurality of light emitting devices 50 and a plurality of optical devices 10 mounted on a substrate 1111 to be lengthwise arranged along the substrate 1111 (see FIG. 11).

In the housing 1120, the light source module 1110 may be fixedly mounted on one surface 1122 of the housing, and the housing 1120 may allow heat generated by the light source module 1110 to be discharged to the outside. To this end, the housing 1120 may be formed using a material having excellent heat conductivity, for example, a metal, and a plurality of radiation fins 1121 may be protruded from both side surfaces thereof.

The light source module 1110 may be installed on one surface 1122 of the housing 1120.

The cover 1140 may be coupled to a stop groove 1123 of the housing 1120 so as to cover the light source module 1110. In addition, the cover 1140 may have a hemispherical curved surface so as to allow for light generated by the light source module 1110 to be uniformly irradiated externally. The cover 1140 may be provided with protrusions 1141 formed on lower portions of the cover in a length direction thereof so as to be engaged with the stop groove 1123 of the housing 1120.

The terminal portion 1130 may be provided at at least one open end of both distal ends of the housing 1120 in the length direction thereof so as to supply power to the light source module 1110 and may include electrode pins 1133 protruding externally.

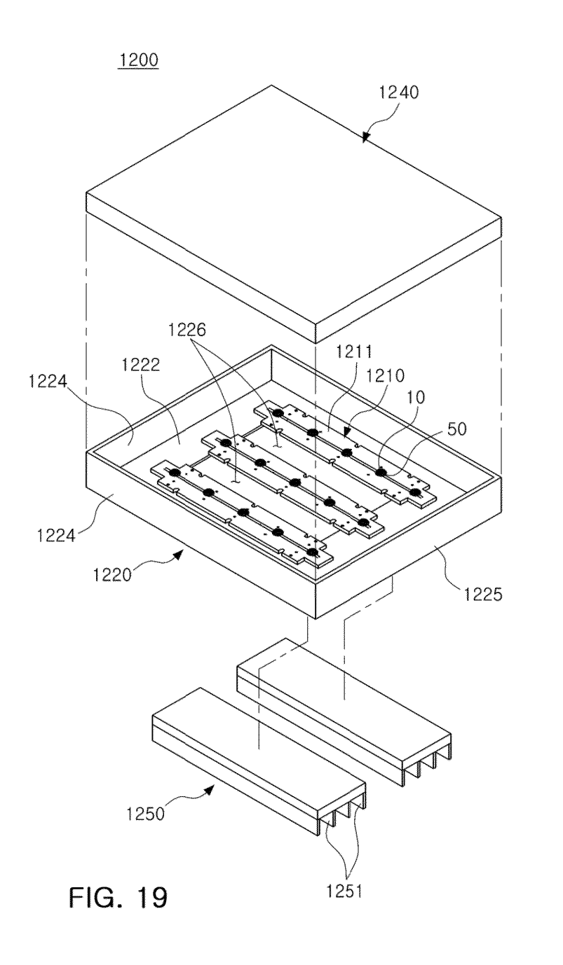

FIG. 19 is a schematic exploded perspective view of a lighting device according to another exemplary embodiment of the present disclosure. With reference to FIG. 19, a lighting device 1200 may have a surface light source type structure by way of example, and may include a light source module 1210, a housing 1220, a cover 1240 and a heat sink 1250.

As the light source module 1210, the light source module provided with reference to FIG. 11 maybe employed. Thus, a detailed description thereof will be omitted. The light source module 1210 may be configured to include a plurality of light emitting devices 50 and a plurality of optical devices 10 mounted on a substrate 1211 to be lengthwise arranged along the substrate 1211 (see FIG. 11).

The housing 1220 may have a box-type structure formed by one surface 1222 thereof on which the light source modules 1210 are mounted and by sides 1224 thereof extended from edges of the one surface 1222. The housing 1220 may be formed using a material having excellent heat conductivity, for example, a metal, so as to allow heat generated by the light source modules 1210 to be discharged to the outside.

A hole 1226 through which the heat sinks 1250 to be described below are inserted to be coupled thereto may be formed to penetrate through the one surface 1222 of the housing 1220. In addition, the substrate 1211 of the light source module 1210 mounted on the one surface 1222 may be partially suspended across the hole 1226 to be exposed externally.

The cover 1240 may be coupled to the housing 1220 to cover the light source modules 1210. The cover 1240 may have a substantially flat structure.

The heat sink 1250 may be coupled to the hole 1226 through a different surface 1225 of the housing 1220. In addition, the heat sink 1250 may contact the light source modules 1210 through the hole 1226 to discharge heat of the light source modules 1210 to the outside. In order to improve heat radiation efficiency, the heat sink 1250 may include a plurality of radiation fins 1251. The heat sink 1250 may be formed using a material having excellent heat conductivity like a material of the housing 1220.

A lighting device using a light emitting device may be largely classified as an indoor LED lighting device and an outdoor LED lighting device. The indoor LED lighting device may mainly be used in a bulb-type lamp, an LED-tube lamp, or a flat-type lighting device, as an existing lighting device retrofit, and the outdoor LED lighting device may be used in a streetlight, a safety lighting fixture, a light transmitting lamp, a landscape lamp, a traffic light, or the like.

In addition, a lighting device using LEDs may be utilized as internal and external light sources in vehicles. As the internal light source, the lighting device using LEDs maybe used as interior lights for motor vehicles, reading lamps, various types of light source for an instrument panel, and the like, and as the external light sources used in vehicles, the lighting device using LEDs may be used in all types of light sources such as headlights, brake lights, turn signal lights, fog lights, running lights for vehicles, and the like.

Furthermore, as light sources used in robots or in various kinds of mechanical equipment, LED lighting devices may be applied. In detail, an LED lighting device using light within a special wavelength band may promote the growth of a plant, may stabilize people's moods, or may also be used therapeutically, as emotional lighting.

According to an exemplary embodiment in the present disclosure, an optical device by which color mura may be prevented and uniform light distribution may be obtained is provided.

While exemplary embodiments have been shown and described above, it will be apparent to those skilled in the art that modifications and variations could be made without departing from the scope of the present disclosure as defined by the appended claims.

What is claimed is:

1. An optical device comprising:
a first surface facing a light source, and including a recess portion formed in a central portion of the first surface through which an optical axis of light passes and a concave-convex pattern disposed around the recess portion, the recess portion being recessed in a direction in which the light is emitted; and
a second surface which is disposed to oppose the first surface and at which the light incident through the recess portion is refracted and emitted externally,
wherein the concave-convex pattern includes a plurality of convex portions and a plurality of concave portions alternatively and repetitively arranged in a direction outwardly from the recess portion toward an edge at which the first surface is connected to the second surface.

2. The optical device of claim 1, wherein the concave-convex pattern further comprises a plurality of protrusions arranged on surfaces of the plurality of convex portions.

3. The optical device of claim 2, wherein the plurality of protrusions are extendedly arranged from a respective convex portion to a respective concave portion.

4. The optical device of claim 1, wherein the plurality of respective convex portions have step structures.

5. The optical device of claim 1, wherein the concave-convex pattern has a form in which at least a portion of peaks of protrusions of the plurality of convex portions are disposed on a same plane as the first surface.

6. The optical device of claim 1, wherein the concave-convex pattern has a form in which at least a portion of vertices of recessed portions of the plurality of concave portions are disposed on a same plane as the first surface.

7. The optical device of claim 1, wherein the plurality of concave portions and the plurality of convex portions are arranged to form concentric circles, based on the optical axis, respectively.

8. The optical device of claim 1, wherein the plurality of concave portions and the plurality of convex portions are disposed to have a spirally arranged form, based on the optical axis.

9. The optical device of claim 1, wherein the second surface comprises a first curved surface recessed along the optical axis toward the recess portion to have a concave curved surface, and a second curved surface having a convex curved surface continuously extended from an edge of the first curved surface to an edge of the second curved surface connected to the first surface.

10. The optical device of claim 1, wherein the recess portion is disposed above the light source to oppose the light source.

11. The optical device of claim 1, wherein a transverse cross-sectional area of the recess portion exposed to the first surface is larger than that of the light source.

12. The optical device of claim 1, further comprising a support portion provided on the first surface.

13. An optical device comprising:
a first surface facing a light source, and including a recess portion formed in a central portion of the first surface through which an optical axis of light passes and a concave-convex pattern disposed around the recess portion, the recess portion being recessed in a direction in which the light is emitted; and
a second surface which is disposed to oppose the first surface and at which the light incident through the recess portion is refracted and emitted externally,
wherein the concave-convex pattern includes a plurality of convex portions protruded from the first surface, and the plurality of convex portions include a plurality of protrusions arranged on surfaces of the plurality of convex portions.

14. The optical device of claim 13, wherein the concave-convex pattern is repeatedly arranged in a direction outwardly from the recess portion toward an edge at which the first surface is connected to the second surface.

15. The optical device of claim 13, wherein the concave-convex pattern has a structure in which the plurality of convex portions are arranged to form concentric circles, based on the optical axis, respectively.

16. An optical device, comprising:
a ring-shaped flat surface;
a recess portion recessed away from an inner portion of the ring-shaped flat surface;
a plurality of convex portions and a plurality of concave portions alternatively arranged from an outer portion of the ring-shaped flat surface along a direction away from an axis which passes through a center of the recess portion and which is perpendicular to the ring-shaped flat surface; and
a second surface opposed to recess portion, the ring-shaped flat surface, the plurality of convex portions, and the plurality of concave portions,
wherein a major body of the optical device is encompassed by a surface of the recess portion, the ring-shaped flat surface, surfaces of the plurality of convex portions, surfaces of the plurality of concave portions, and the second surface.

17. The optical device of claim 16, wherein along the direction away from the axis, a level of the second surface first increases and then decreases with reference to a level of the ring-shaped flat surface.

18. The optical device of claim 16, wherein the plurality of convex portions have a plurality of protrusions arranged on the surfaces thereof or have step structures formed on the surfaces thereof.

19. The optical device of claim 16, further comprising a support portion protruding from the ring-shaped flat surface.

20. The optical device of claim 16, wherein the plurality of concave portions and the plurality of convex portions are arranged to form concentric circles with reference to the axis, respectively, or have a spirally arranged form with reference to the axis.
